(19) United States
(12) Patent Application Publication
(10) Pub. No.: US 2014/0358543 A1
(43) Pub. Date: Dec. 4, 2014

(54) LINKED-WORK ASSISTANCE APPARATUS, METHOD AND PROGRAM

(71) Applicant: KABUSHIKI KAISHA TOSHIBA, Tokyo (JP)

(72) Inventors: Tetsuro CHINO, Kawasaki-shi (JP); Kentaro TORRI, Yokohama-shi (JP); Naoshi UCHIHIRA, Kawasaki-shi (JP)

(73) Assignee: KABUSHIKI KAISHA TOSHIBA, Tokyo (JP)

(21) Appl. No.: 14/199,238

(22) Filed: Mar. 6, 2014

(30) Foreign Application Priority Data
May 30, 2013 (JP) 2013-113951

(51) Int. Cl. G10L 15/08

(52) U.S. Cl. CPC G10L 15/08
USPC 704/254

(57) ABSTRACT

According to one embodiment, a linked-work assistance apparatus includes an analysis unit, an identification unit and a control unit. The analysis unit analyzes a speech of each of users by using a keyword list, to acquire a speech analysis result indicating a relation between a first keyword and a classification of the first keyword, the keyword list indicating a list of keywords classified based on concepts of the keywords and intentions of the keywords. The identification unit identifies a role of each of the users according to the classification of the first keyword, to acquire a correspondence relation between each of the users and the role. The control unit, if the speech includes a name of the role, transmits the speech to other users which relate to the role corresponding to the name, by referring to the correspondence relation.

### CROSS-REFERENCE TO RELATED APPLICATIONS

This application is based upon and claims the benefit of priority from Japanese Patent Application No. 2013-113951, filed May 30, 2013, the entire contents of which are incorporated herein by reference.

### FIELD

Embodiments described herein relate generally to a linked-work assistance apparatus, method and program.

### BACKGROUND

Medical care and nursing care are achieved by the coordinated work of many helpers specialized in various types of care. In most cases, the helpers work at places that are spatially remote from one another. To achieve the coordinate work, remote communication must be performed between the helpers.

The remote communication can be performed by the helpers using the mail software available or by writing messages on the whiteboard or message board installed in a room they share. Alternatively, the remote communication may be achieved by the helpers using fixed extension telephones, a personal handy phone (PHS) system, mobile telephones, transceivers, an intercommunication system, or an Internet Protocol (IP) telephone system, electronic conference system or speech-controlling wireless communication system, each using a wireless communication infrastructure (e.g., wireless LAN installed in the premises). Still alternatively, the remote communication between the helpers may be achieved by the helpers talking to each other while working. Such various media are used in combination, accomplishing the communication between the helpers.

### BRIEF DESCRIPTION OF THE DRAWINGS

FIG. 1 is a block diagram illustrating a linked-work assistance system according to a first embodiment;

FIG. 2 is a diagram illustrating an example of speech information acquired in a communication control unit;

FIG. 3 is a diagram illustrating an example of keyword list;

FIG. 4 is a diagram illustrating an example of speech analysis result;

FIG. 5 is a diagram illustrating an example of utterance-pair detection rule;

FIG. 6 is a diagram illustrating an example of utterance-pair detection result;

FIG. 7 is a flowchart explaining the operation of the linked-work assistance apparatus according to the first embodiment;

FIG. 8 is a diagram illustrating an example of a correspondence relation table;

FIG. 9 is a diagram illustrating how a correspondence relation table changes with time if roles are added and changed; and

FIG. 10 is a block diagram illustrating a linked-work assistance system according to a second embodiment.

### DETAILED DESCRIPTION

In facilities providing medical care and nursing service, many helpers perform various types of specialized care work, cooperating one with another in accordance with the needs that change with time. It is better for helpers to use “role names” instead of their actual personal names, to call one another for assistance, as is pointed out by experts in medical and nursing care. Some of the existing remote-communication assisting techniques can identify a helper with his or her role name only or with both the role name and his or her personal name.

In these facilities, however, the needs change from time to time, and so does the “role” of each helper. Moreover, the “role” frequently changes when the helper is busy working, and the existing remote-communication assisting technique cannot keep registering the role changes. Further, the change of “role” cannot be detected from the speech of each helper, and the helper cannot be called for a new “role.”

In most of these facilities, such as medical care centers and nursing centers, a limited number of helpers provide services to many people. Any helper may need to serve several persons at the same time. In this case, the helper may be too busy to contact the other helpers for assistance or to inform them of his or her busy state.

In general, according to one embodiment, a linked-work assistance apparatus includes an analysis unit, an identification unit and a control unit. The analysis unit is configured to analyze a speech of a user by using a keyword list, to acquire a speech analysis result indicating a relation between a first keyword and a classification of the first keyword if the first keyword included in the speech, the keyword list indicating a list of keywords classified based on concepts of the keywords and intentions of the keywords, the first keyword being one of the keywords included in the keyword list. The identification unit is configured to identify a role of the user according to the classification of the first keyword, to acquire a correspondence relation between a plurality of users and the roles corresponding to the users. The control unit is configured to, if the speech includes a name of the role, transmit the speech to one or more other users which relate to the role corresponding to the name, by referring to the correspondence relation.

A linked-work assistance apparatus, method and program according to one embodiment will be described in detail, with reference to the accompanying drawings. Note that another embodiment will be described herein after, but its components identical to those of the first embodiment are designated by the same reference numbers and are not described repeatedly.

### First Embodiment

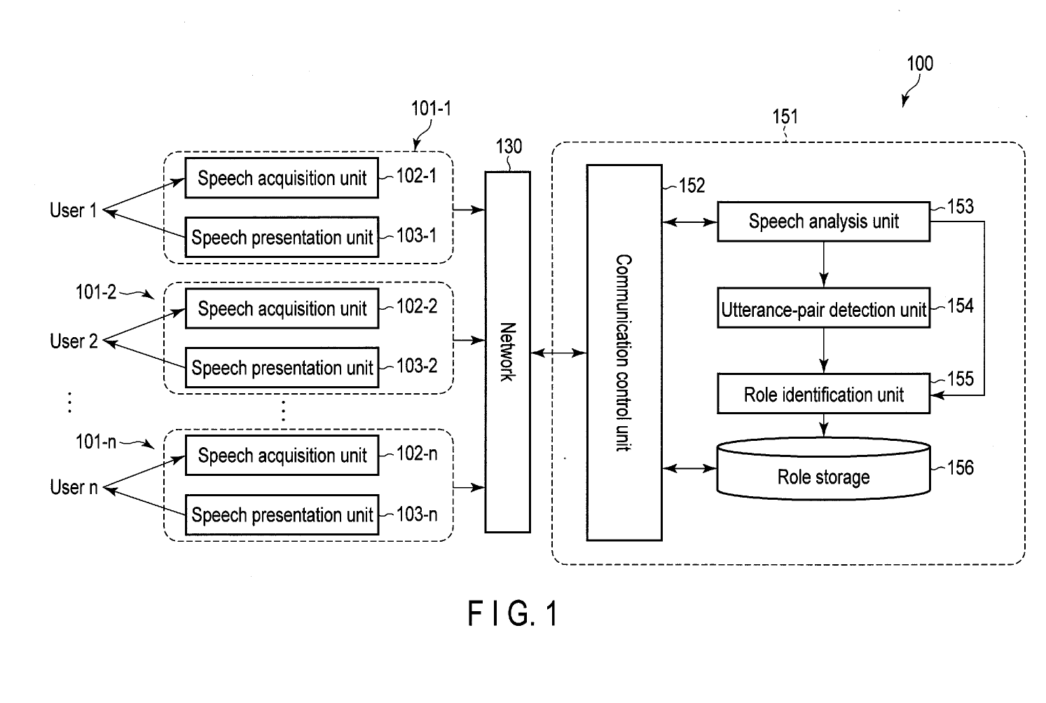

A linked-work assistance system according to a first embodiment, which includes a linked-work assistance apparatus, will be described with reference to the block diagram of FIG. 1.

The linked-work assistance system 100 according to this embodiment includes terminals 101 and a linked-work assistance apparatus 151. A number n of terminals 101 are provided. That is, the system 100 has terminals 101-1 to 101-n. The terminals 101-1 to 101-n are identical in configuration.

Each terminal 101 includes a speech acquisition unit 102 and a speech presentation unit 103. The linked-work assistance apparatus 151 includes a communication control unit 152, a speech analysis unit 153, an utterance-pair detection unit 154, a role identification unit 155, and a role storage 156.

The speech acquisition unit 102 includes, for example, a microphone, an amplifier (signal amplifier), an analog-to-digital (A/D) converter, and a memory. The speech acquisition unit 102 acquires an electric signal representing the speech waveform of the user, and converts the electric signal to speech waveform data. The speech waveform data is transmitted, as speech information via a network 130 to the linked-work assistance apparatus 151, together with at least one of the time data representing a time when the speech is acquired, the identifier (ID) data of the user and the ID data of the terminal including the speech acquisition unit 102.

The speech presentation unit 103 includes, for example, a memory, a digital-to-analog (D/A) converter, an amplifier (signal amplifier) and a speaker or earphone. The speech presentation unit 103 receives the speech waveform data via the network 130 from the linked-work assistance apparatus 151, and presents the speech waveform data in the form of a speech signal to the user.

The network 130 is a wireless or wired digital communication network, which includes cables, transceivers, routers, switches, wireless LAN access points and wireless LAN transmitter/receivers.

The communication control unit 152 receives the speech information from the speech acquisition unit 102 of the terminal 101. The communication control unit 152 may receive, from any terminal, a message based on a role, such as an instruction about the role being performed. In this case, the communication control unit 152 transmits the speech waveform data to the terminal of the user corresponding to the role, in accordance with the correspondence relation stored in the role storage 156, which will be described later. In this embodiment, for example, any role a helper may perform is defined by the work name, position name, group name, team name, shift name, target name, service-receiver name or service-place name, and service time which relate to the user.

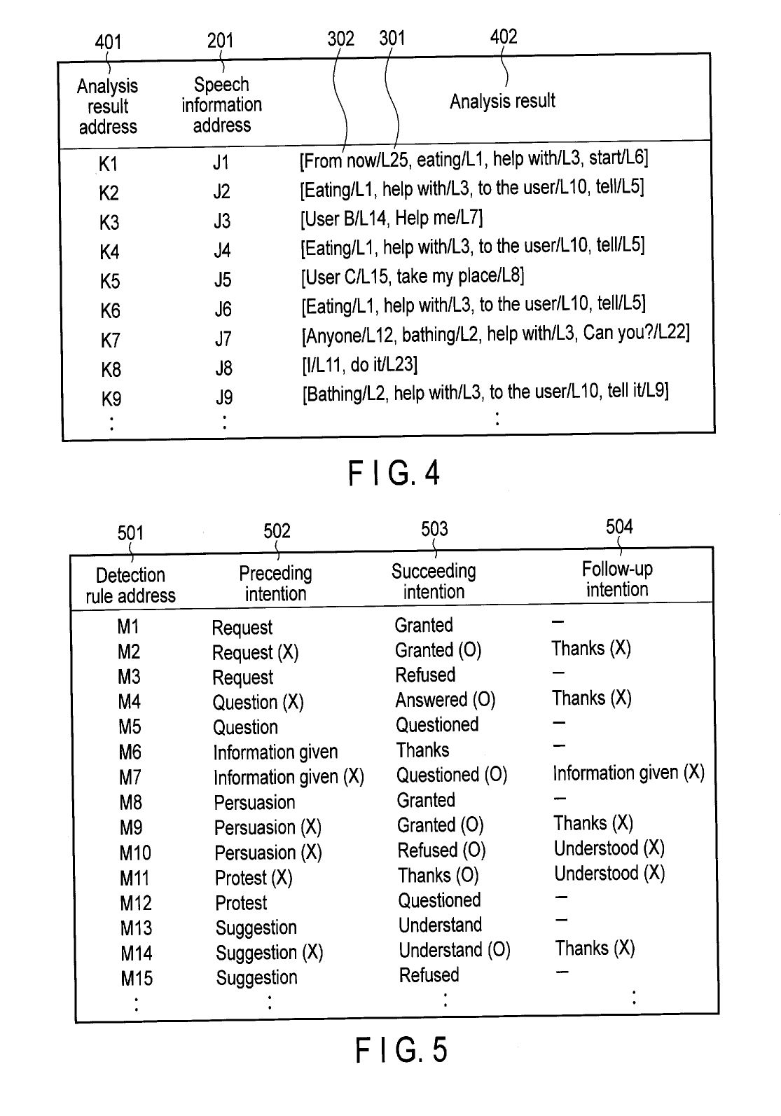

The speech analysis unit 153 receives the speech information about each user from the communication control unit 152, performs a speech analyzing process and a keyword spotting process on the speech information. The speech analysis unit 153 extracts keywords from the speech information and acquires, for each user, a speech analysis result, i.e., the relation between the keywords and the classifications thereof. In the speech analyzing process, for example, phoneme detection, power analysis, fast Fourier transform (FFT) and spectrum analysis may be performed on the speech waveform data. Alternatively, the speech waveform data may be subjected to a voice recognition process. In the voice recognition process, the speech waveform data is compared or collated with a voice-recognition vocabulary composed of acoustic models and language models, in the hidden Markov model (HMM), a neural network (NN), a dynamic programming (DP) or a weighted finite-state transducer (WFST). The keyword spotting process is a process in which a keyword list (described later) is collated with the voice-recognition vocabulary, thereby to acquire the keywords included in the speech waveform data. The speech analysis result will be described later, with reference to FIG. 4.

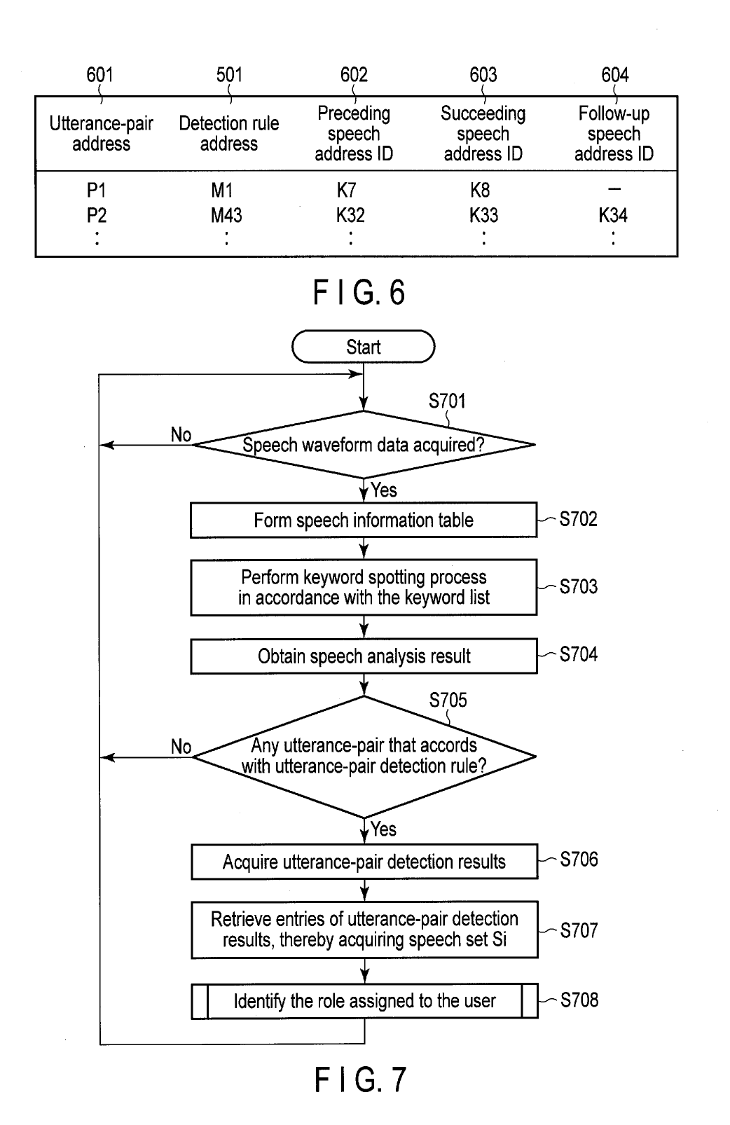

The utterance-pair detection unit 154 receives the speech analysis result from the speech analysis unit 153. The utterance-pair detection unit 154 then detects the utterance-pair representing the relation of speeches, from the keyword combinations included in the dialogs between the users in accordance with the utterance-pair detection rule (described herein later), thereby acquiring an utterance-pair detection result. The utterance-pair detection result will be explained later with reference to FIG. 6.

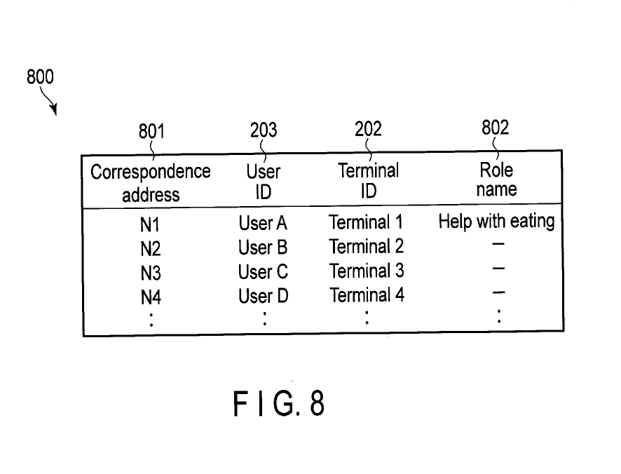

The role identification unit 155 receives the speech analysis result from the speech analysis unit 153, and the utterance-pair detection result from the utterance-pair detection unit 154. The role identification unit 155 identifies the roles of the users from the classifications of keywords based on the speech analysis result and the utterance-pair detection result, and then generates a correspondence relation table indicating the relation between the users and the user's role. The correspondence relation table will be described later with reference to FIG. 8.

The role storage 156 receives the correspondence relation table from the role identification unit 155 and stores the correspondence relation table.

An example of speech information acquired in the communication control unit 152 will be described.

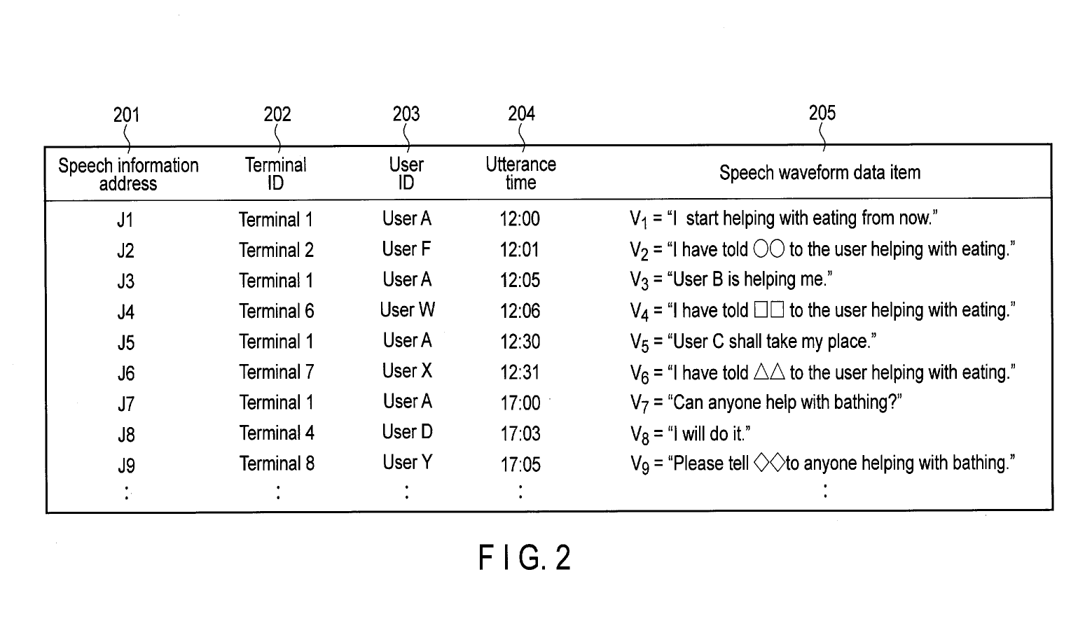

FIG. 2 shows the speech information table storing the speech information. As shown in FIG. 2, the speech information table includes speech information address 201, terminal identifier (terminal ID) 202, user identifier (user ID) 203, utterance time 204, and speech waveform data item 205, which are associated one with another. The speech information address 201 is the identifier of the respective entry in the speech information table. The terminal ID 202 is the identifier of the terminal that has acquired the utterances of the user. The user ID 203 is the identifier of the user using the respective terminals. The utterance time 204 is the time the speech waveform data was acquired. The speech waveform data item 205 is digitized speech waveform data.

For example, the speech information address 201 “J1,” the terminal ID 202 “terminal 1,” the user ID 203 “user A,” the utterance time 204 “12:00” and the speech waveform data item 205 “I start helping with eating from now” are associated, one with another. The entry at the address J1 therefore indicates the speech digital-waveform data representing the speech of “I start helping with eating from now” the user A has uttered to the terminal 1 at 12:00. In the speech information table of FIG. 2, symbols “◯◯,” “ [symbol] ,” “ [symbol] ,” and “⋄⋄” are words that need not be exemplified in explaining the present embodiment.

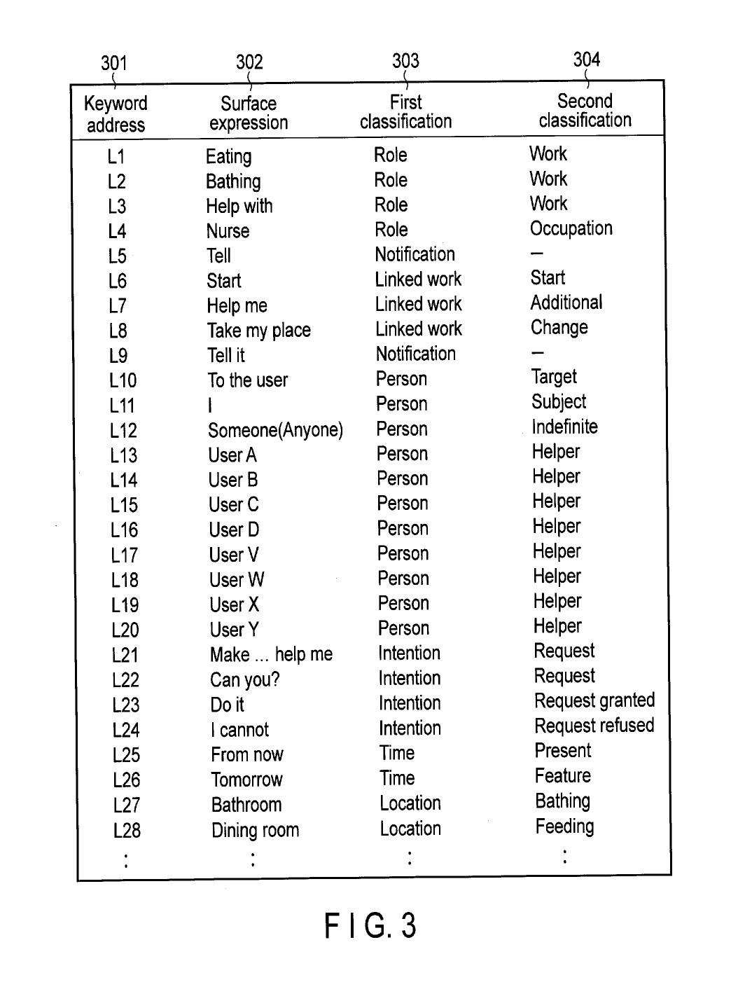

An example of the keyword list the speech analysis unit 153 may use will be explained with reference to FIG. 3.

In the keyword list shown in FIG. 3, each entry includes a keyword address 301, a surface expression 302, a first classification 303 and a second classification 304, which are associated with one another.

The keyword address 301 is the identifier identifying the entry of one keyword. The surface expression 302 is a character string expressing the surface expression of the keyword and is compared with the speech information. The character string may be composed of only one character in some cases. The first classification 303 represents a classification based on the intention of the speech and the concept of the keyword of surface expression 302. The second classification 304 represents the classification of the keyword, more detailed than the classification represented by the first classification 303.

For example, the keyword address 301 “L1,” the surface expression 302 “eating,” the first classification 303 “role” and the second classification 304 “work” are associated, one with another. In the entry for which the first classification is “intention,” the second classification is the detailed intention of the speech uttered. The keyword list may be prepared from an external database or by compiling the words the users have manually input. Alternatively, the keyword list may be prepared by extracting the intentions of the speeches input, by using a method generally known. In this embodiment, two classifications are available, i.e., a first classification and a second classification. Instead, one classification may be set, or three or more classifications may be set.

An example of a speech analysis result acquired by the speech analysis unit 153 will be explained with reference to FIG. 4.

As shown in FIG. 4, an analysis result address 401, a speech information address 201 and an analysis result 402 are associated with each other, as the speech analysis result.

The analysis result address 401 is the identifier that identifies one entry, i.e., a speech analysis result.

The analysis result 402 is the result of analyzing the speech waveform data and is a combination of the surface expression 302 of the keyword extracted and the keyword address 301 of the associated entry in the keyword list.

At the analysis result address 401 “K1,” for example, the speech information address 201 “J1” is associated with the analysis result 402 “From now/L25, eating/L1, help with/L3, start/L6.” That is, as the result of analyzing the speech information at the speech information address J1, four keywords have been extracted. Of these keywords, the surface expression “From now” corresponds to the entry “L25” at the keyword address 301 in the keyword list of FIG. 3, the surface expression “eating” corresponds to the entry “L1” at the keyword address 301, the surface expression “help with” corresponds to the entry “L3” at the keyword address 301, and the surface expression “start” corresponds to the entry “L6” at the keyword address 301.

The utterance-pair detection rule used in the utterance-pair detection unit 154 will be explained with reference to FIG. 5.

Each entry in the utterance-pair detection rule includes a detection rule address 501, a preceding intention 502, a succeeding intention 503 and a follow-up intention 504 in association with each other.

The detection rule address 501 is an identifier that identifies an entry in the utterance-pair detection rule. The preceding intention 502 is the second classification 304 of the keyword included in the speech. The succeeding intention 503 is the second classification 304 of the keyword included in the speech and following the preceding intention 502. The follow-up intention 504 is the second classification 304 of the keyword included in the speech and following the succeeding intention 503.

In the entry of the detection rule address 501 “M1,” for example, speech information may be detected, which includes a keyword whose first classification and second classification are an intention and a “request,” respectively, and speech information may then be detected, which includes a key word whose first classification and second classification are an intention and a “granted,” respectively. In this case, the two pieces of speech information constitute an utterance-pair in accordance with the utterance-pair detection rule.

In the entry of the detection rule address 501 “M4,” speech information may be detected, which includes a keyword whose first classification is all “intention,” and three pieces of speech information may be detected, which include a keyword whose second classification consists of a preceding intention “question,” a succeeding intention “answered” and a follow-up intention “thanks.” In this case, the three pieces of speech information constitute an utterance-pair in accordance with the utterance-pair detection rule.

An utterance-pair may include up to the flow-up intention as in the detection rule addresses M2 and M4. In such a case, information indicating which should be assigned to the speech utterer (i.e., user), in order to specify the speech of the user whose role has been identified by the role identification unit 155. Concretely example, the information indicates request (X), granted (◯) or thanks (X).

The utterance-pair detection rule may impose some restrictions. For example, the user who has uttered a speech including the preceding intention must be identical to the user who has uttered a speech including the follow-up intention corresponding to the preceding intention and be different from the user who has uttered the succeeding intention corresponding to the preceding intention. Further, the time intervals of uttering speeches may be restricted.

An example of an utterance-pair detection result acquired by the utterance-pair detection unit 154 will be explained with reference to FIG. 6.

Each entry of the utterance-pair detection result is associated with an utterance-pair address 601, a detection rule address 501, a preceding speech address ID 602, a succeeding speech address ID 603, and a follow-up speech address 604.

The utterance-pair address 601 is the identifier identifying one entry of the utterance-pair detection result. The preceding speech address ID 602 is the analysis result address 401 of the analysis of the speech detected as composing an utterance-pair.

The succeeding speech address ID 603 is the analysis result address 401 of the analysis of the speech uttered after the speech identified by the preceding speech ID 602, detected as composing the utterance-pair.

The follow-up speech address 604 is the analysis result address 401, i.e., results of analyzing the speech uttered after the speech identified by the succeeding speech ID 603, detected as composing the utterance-pair.

In the entry β1 of the utterance-pair address 601, for example, the speech data “K8” at the analysis result address 401 is detected on the basis of the detection rule address 501 “M1” detected as preceding speech address ID 602, and the speech data “K9” at the analysis result address 401 is detected as succeeding speech address ID 603. These two speeches show that the utterance-pair corresponds to the detection rule address 501 “M1.” Note that in FIG. 6, the sign “-” indicates the absence of the information.

A process of the linked-work assistance apparatus according to this embodiment will be explained with reference to the flowchart of FIG. 7.

In Step S701, the communication control unit 152 waits for speech waveform data coming from the terminal 101 through the network. If the communication control unit 152 receives the speech waveform data, the process proceeds to Step S702. If the communication control unit 152 does not receive the speech waveform data, Step S701 is repeated until the communication control unit 152 receives the speech waveform data.

In Step S702, the speech analysis unit 153 extracts the terminal ID, user ID, utterance time and speech waveform, all included in the speech waveform data, and then associates these data items, creating a speech information table.

In Step S703, the speech analysis unit 153 performs the keyword spotting process on the speech data, in accordance with the keyword list.

In Step S704, the speech analysis unit 153 associates the surface expression of the keyword acquired in the keyword spotting process, with the keyword address held in the corresponding keyword list, thereby obtaining a speech analysis result.

In Step S705, the utterance-pair detection unit 154 refers to the keyword addresses of the keywords included in the entry of the speech analysis result, thus extracting the first and second classifications of each keyword. The utterance-pair detection unit 154 then determines whether or not any utterance-pair exists, in which the combination of the first and second classifications accords with the utterance-pair detection rule. If such utterance-pair exits, the process proceeds to Step S706. If such utterance-pair does not exist, the process returns to Step S701, and repeats Steps S701 to S705.

In Step S706, the utterance-pair detection unit 154 extracts, for all utterance-pairs newly detected, the detection rule addresses and analysis result addresses of preceding speech IDs, succeeding speech IDs and flow-up speech IDs. Using the detection rule addresses and analysis result addresses so extracted, the Utterance-pair detection unit 154 generates entries of utterance-pair detection results.

In Step S707, the role identification unit 155 refers to the utterance-pair detection results, retrieving the entries included in at least any one of the preceding speech IDs, succeeding speech IDs and flow-up speech IDs. The role identification unit 155 then adds the speech being processed, to the union of the preceding speech IDs, succeeding speech IDs and flow-up speech IDs appearing in the utterance-pair detection results.

In Step S708, the role identification unit 155 performs a role identifying processing which identifies the role assigned to the user. After the role identifying processing being performed, the process returns to Step S701, and repeats Steps S701 to S708. Note that any step shown in FIG. 7 can be terminated in response to the user's instructions.

How the role identification unit 155 identifies the role in Step S708 will be explained below in detail.

In this embodiment, the role assigned to the user is identified in accordance with the five process rules specified below. In the notation of <α, β, γ, δ> used below, α is the speech waveform data, β is the surface expression of keyword, γ is the first classification and δ is the second classification.

The letters and numerals in capitals indicate variables for values, and any identical variables described in each rule represent identical values. Sign “-” indicates information that need not be considered in the process. In this embodiment, five process rules are used. Nonetheless, six or more process rules, or four or less process rules may be used.

### <Process Rule 1>

Rule 1 pertains to the process performed if any entry of the speech analysis result in set Si includes <α1, β1, role, work> and <α1, β2, Linked work, Start>. In the process, the entry Ji in the speech information table corresponding to speech waveform data Vi is referred to, thereby identifying the terminal ID and user IDi of the speech utterer and adding keyword “β1” to the role name of the entry Ni in the correspondence relation table stored in the role storage 156.

### <Process Rule 2>

Rule 2 pertains to the process performed if any entry of the speech analysis result in set Si includes <α1, β1, Person, Worker> and <α1, β2, Linked work, Additional>. In the process, the entry Ji in the speech information table corresponding to speech waveform data Vi is referred to, thereby identifying the user IDi of the speech utterer and extracting the role name “βi” of the entry Ni stored in the role storage 156.

Next, the correspondence relation table (not shown), in which personal names and user IDs are stored, is referred to, acquiring the user IDj corresponding to the keyword β1. Finally, the entry Nj corresponding to the user IDj is retrieved from the role storage 156, and “βi” is added as a role name for the entry Nj shown in the correspondence relation table.

### <Process Rule 3>

Rule 3 pertains to the process performed if any entry of the speech analysis result in set Si includes <α1, β1, Person, Worker> and <α1, β2, Linked work, Change>. First, the entry Ji in the speech information table corresponding to speech waveform data Vi is referred to, thereby identifying the user IDi of the speech utterer and extracting the role name “βi” of the entry Ni stored in the role storage 156.

Next, the correspondence relation table, in which personal names and user IDs are stored, is referred to, acquiring the user IDj corresponding to the keyword β1. Then, the entry Nj corresponding to the user IDj is retrieved from the correspondence relation table held in the role storage 156, and “βi” is added as role name for the entry Nj. Finally, the role name “β1” for the entry Ni is deleted from the correspondence relation table, and sign “−” is added in the correspondence relation table.

### <Process Rule 4>

Rule 4 pertains to the process performed if any entry of the speech analysis result in set Si includes <α1, β1, Role, Work>, <α1, β2, Intention, Request>, <α3, β4, Person, Subject> and <α3, β4, Intention, Request granted>. First, the entry Jk in the speech information table corresponding to speech waveform data Vk is referred to, thereby acquiring user IDk. Next, the entry Nk corresponding to the user ID is retrieved from the correspondence relation table held in the role storage 156, and “β1” is described, as a role name for the entry Nk, in the correspondence relation table.

### <Process Rule 5>

Rule 5 pertains to the process performed if any entry of the speech analysis result in set Si includes <α1, β1, role, work> and <α1, β2, notification, ->. First, set Ns of entries having role name “β1” is retrieved from the role storage 156. Then, entry J1 corresponding to α1 is retrieved from the correspondence relation table, thereby acquiring the corresponding speech waveform data V1. Next, the corresponding table held in the role storage 156 is referred to, acquiring the set Us of all user IDs and the set Ts of all terminal IDs, which are included in the set Ns. Finally, the speech waveform data V1 is transmitted to all terminals of the set Ts corresponding to the set Us, presenting the speech waveform data V1 to all users of the set Us.

An example of a correspondence relation table generated in accordance with the process rules described above will be explained with reference to FIG. 8.

The role storage 156 stores the corresponding table 800. The corresponding table 800 stored in the role storage 156 has correspondence addresses 801, user IDs 203, terminal IDs 202 and role names 802, one associated with another. The correspondence addresses 801 are identifiers that identify the entries of the correspondence relation table 800, respectively. The role names 802 are the names given to the roles the users identified with the user IDs 203 may perform.

For example, the correspondence addresses 801 “N1,” user ID 203 “User A,” terminal ID 202 “Terminal 1” and the role name “help with eating” are associated with one another.

A concretely example of operation of the linked-work assistance apparatus 151 will be explained with reference to FIG. 2 to FIG. 9.

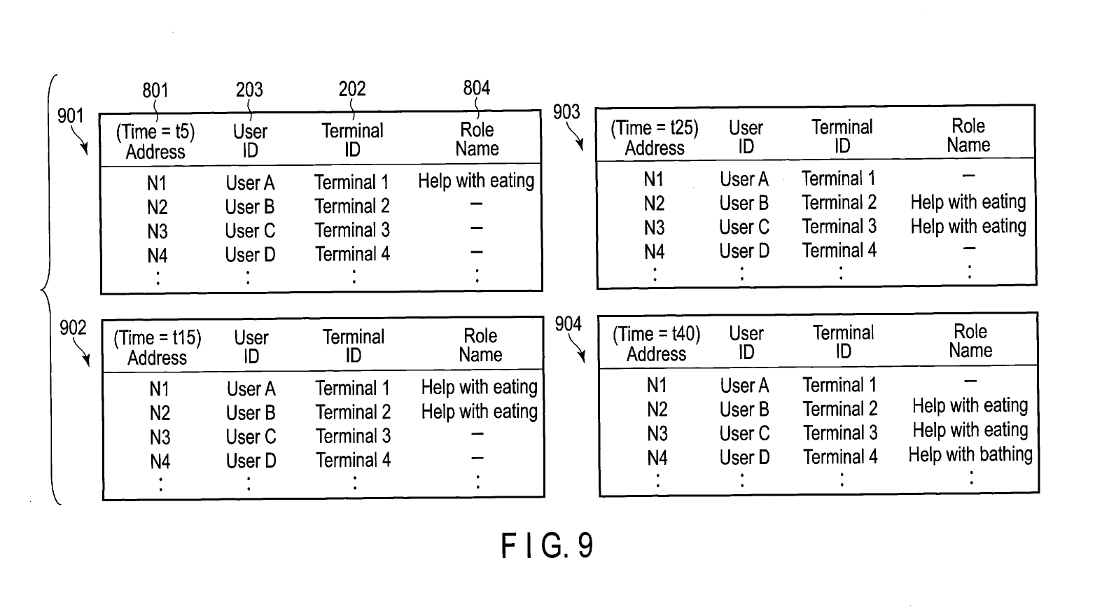

FIG. 9 is a diagram illustrating how the correspondence relation table changes with time if roles are added and changed. FIG. 9 pertains to the case where users A, F, D, W, X and Y perform linked works, while remote-communicating with one another by utilizing the linked-work assistance apparatus according to this embodiment. Symbols (t0) to (t45) each indicate the time of performing a process.

(t0) First, the terminal 1 of the user A acquires the following speed waveform data V1 representing the speech the user A has uttered.

V1=User A: “I start helping with eating from now.” (t1) The speech analysis unit 153 performs a process of Step S702 (shown in FIG. 7) on the speech waveform data V1, generating an entry corresponding to the speech information address 201 “J1” (shown in FIG. 2).

(t2) The speech analysis unit 153 refers to the keyword list and then performs a keyword spotting process, thus acquiring the speech analysis result for the entry corresponding to the analysis result address 401 “K1” (shown in FIG. 4).
(t3) The utterance-pair detection unit 154 detects whether or not any utterance-pair has been made. No utterance-pairs are detected, because only speech waveform data V1 has been generated.
(t4) The role identification unit 155 generates set S1 only including the speech waveform data V1.
(t5) The Role identification unit 155 performs a role identifying process on the speech waveform data V1. On the basis of the speech waveform data V1 included in the set S1, there can be extracted <I start helping with eating from now,” Eating, Role, Work>, <I start helping with eating from now,” Help with, Role, Work>, and <I start helping with eating from now,” Start, Linked work, Start>. Since the combination of these items accords with <Process Rule 2>, “eating” and “help with” are identified as new role names for the user A. “help with eating” is therefore recorded in the role name 802 of the entry “N1” in the correspondence relation table 901 (FIG. 9) stored in the role storage 156.
(t6) Next, it is assumed that the following speech waveform data V2 is acquired, as the speech of the user F, from the terminal 2.

V2=User F: “I have told ◯◯ to the user helping with eating.”

(t7) The speech analysis unit 153 performs Step S702 shown in FIG. 7, generating the entry corresponding to the speech information address 201 “J2” in the speech information table shown in FIG. 2. The speech analysis unit 153 then refers to the keyword list, performing the keyword spotting process on the speech data V2 and acquiring the speech analysis result for the entry corresponding to the analysis result address 401 “K2” shown in FIG. 4.
(t8) The utterance-pair detection unit 154 determines whether or not any utterance-pair exists. No utterance-pairs are detected, because neither speech waveform data V1 nor the speech waveform data V2 has a pattern that accords with the utterance-pair detection rule.
(t9) The role identification unit 155 generates set S2 only including the speech waveform data V2.
(t10) The role identification unit 155 identifies the speech waveform data V2. From the speech waveform data V2 existing in the set S2, there can be extracted <“I have told ◯◯ to the user helping with eating,” Eating, Role, Work>, <“I have told ◯◯ to the user helping with eating,” Help with, Role, Work> and <“I have told ◯◯ to the user helping with eating,” Tell, notification, ->. Since the combination of these items accords with <Process Rule 5>, the speech waveform data V2, the speech of “I have told ◯◯ to the user helping with eating” is conveyed to the user A assigned to “help with eating” through the terminal 1. Thus, a necessary speech signal is transmitted for the role dynamically allocated to the user A.
(t11) Then, it is assumed that the following speech waveform data V3 is acquired, as the speech of the user A, from the terminal 1.

V3=User A: “User B is helping me.”

(t12) The speech analysis unit 153 performs Step S702 shown in FIG. 7, generating an entry corresponding to the speech information address 201 “J3” in the speech information table shown in FIG. 2. The speech analysis unit 153 then refers to the keyword list, performing the keyword spotting process on the speech data V3 and acquiring the speech analysis result for the entry corresponding to the analysis result address 401 “K3” shown in FIG. 4.
(t13) The utterance-pair detection unit 154 determines whether or not any utterance-pair exists. No utterance-pairs are detected, because none of the speech waveform data V1 to V3 has a pattern that accords with the utterance-pair detection rule.
(t14) The role identification unit 155 generates set S3 only including the speech waveform data V3.
(t15) The role identification unit 155 identifies the speech waveform data V3. From the speech waveform data V3 existing in the set S3, there can be extracted <“User B is helping me,” User B, Person, Worker> and <“User B is helping me,” help me, Intention, Request>. Since the combination of these items accords with <Process Rule 2>, the role of user A who has uttered the speech, i.e., “eating” and “help with” are extracted and recorded in the role-name column for the entry “N2” of user B, in the table 902 shown in FIG. 9.
(t16) Next, it is assumed that the following speech waveform data V4 is acquired, as the speech of the user F, from the terminal 6.

V4=User W: “I have told [symbol] to the user helping with eating.”

(t17) The speech analysis unit 153 performs Step S702 shown in FIG. 7, generating an entry corresponding to the speech information address 201 “J4” in the speech information table shown in FIG. 2. The speech analysis unit 153 then refers to the keyword list, performing the keyword spotting process on the speech data V4 and acquiring the speech analysis result for the entry corresponding to the analysis result address 401 “K4” shown in FIG. 4.
(t18) The utterance-pair detection unit 154 determines whether or not any utterance-pair exists. No utterance-pairs are detected, because none of the speech waveform data V1 to V4 has a pattern that accords with the utterance-pair detection rule.
(t19) The role identification unit 155 generates set S4 only including the speech waveform data V4.
(t20) The role identification unit 155 identifies the speech waveform data V4. From the speech waveform data V4 existing in the set S4, there can be extracted <“I have told [symbol] to the user helping with eating,” Eating, Role, Work>, <“I have told [symbol] to the user helping with eating,” Help with, Role, Work> and <“I have told [symbol] to the user helping with eating,” Tell, notification, ->. Since the combination of these items accords with <Process Rule 5>, “help with eating” is notified as a role to the users A and B, and the speech waveform data V4 of the user W through the terminals 1 and 2, respectively. Thus, a necessary speech signal can be transmitted also to the user B additionally assigned with the same role the user A.
(t21) Then, it is assumed that the following speech waveform data V5 is acquired, as the speech of the user A, from the terminal 1.

V5=User A: “User C shall take my place.”

(t22) The speech analysis unit 153 performs Step S702 shown in FIG. 7, generating an entry corresponding to the speech information address 201 “J5” in the speech information table shown in FIG. 2. The speech analysis unit 153 then refers to the keyword list, performing the keyword spotting process on the speech data V5 and acquiring the speech analysis result for the entry corresponding to the analysis result address 401 “K5” shown in FIG. 4.
(t23) The utterance-pair detection unit 154 determines whether or not any utterance-pair exists. No utterance-pairs are detected, because none of the speech waveform data V1 to V5 has a pattern that accords with the utterance-pair detection rule.
(t24) The role identification unit 155 generates set S5 only including the speech waveform data V5.
(t25) The role identification unit 155 identifies the speech waveform data V5. From the speech waveform data V5 existing in the set S5, there can be extracted <“User C shall take my place,” User C, Person, Worker> and <“User C shall take my place,” take my place, Linked work, Additional>. Since the combination of these items accords with <Process Rule 3>, the role of the user A, i.e., “help with eating,” is extracted and recorded in the role-name column for the entry “N3” of the user C, in the table 903 shown in FIG. 9. Further, the sign “-” indicating the absence of a role is recorded in the role-name column for the entry “N1” of the user A.
(t26) Next, it is assumed that the following speech waveform data V6 is acquired, as the speech of the user X, from the terminal 7.

V6=User X: “I have told [symbol] to the user helping with eating.” (t27) The speech analysis unit 153 performs Step S702 shown in FIG. 7, generating an entry corresponding to the speech information address 201 “J6” in the speech information table shown in FIG. 2. The speech analysis unit 153 then refers to the keyword list, performing the keyword spotting process on the speech data V6 and acquiring the speech analysis result for the entry corresponding to the analysis result address 401 “K6” shown in FIG. 4.

(t28) The utterance-pair detection unit 154 determines whether or not any utterance-pair exists. No utterance-pairs are detected, because none of the speech waveform data V1 to V6 has a pattern that accords with the utterance-pair detection rule.
(t29) The role identification unit 155 generates set S4 only including the speech waveform data V6.
(t30) The role identification unit 155 identifies the speech waveform data V6. From the speech waveform data V6 existing in the set S4, there can be extracted <“I have told [symbol] to the user helping with eating,” eating, Role, Work>, <“I have told [symbol] to the user helping with eating,” help with, Role, Work> and <“I have told [symbol] to the user helping with eating,” Tell, Notification, ->. Since the combination of these items accords with <Process Rule 5>, the user X's speech waveform data V6, “I have told [symbol] to the user helping with eating,” is notified to the user C, as well as to the user B assigned with the role “helping with eating.” Thus, a necessary speech signal can be transmitted also to the user C assigned with the same role the user A. At this time, unnecessary communication can be avoided, because the speech waveform data V6 is not transmitted to the user A who need not be notified at all. Only necessary information is given to the user A, preventing the user A from being confused.
(t31) It is then assumed that the following speech waveform data V7 is acquired, as the speech of the user A, from the terminal 1.

V7=User A: “Can anyone help with bathing?”

(t32) The speech analysis unit 153 performs Step S702 shown in FIG. 7, generating an entry corresponding to the speech information address 201 “J7” in the speech information table shown in FIG. 2. The speech analysis unit 153 then refers to the keyword list, performing the keyword spotting process on the speech data V7 and acquiring the speech analysis result for the entry corresponding to the analysis result address 401 “K7” shown in FIG. 4.
(t33) The utterance-pair detection unit 154 determines whether or not any utterance-pair exists. No utterance-pairs are detected, because none of the speech waveform data V1 to V7 has a pattern that accords with the utterance-pair detection rule.
(t34) The role identification unit 155 generates set S7 only including the speech waveform data V7.
(t35) The role identification unit 155 identifies the speech waveform data V7. From the speech waveform data V7 existing in the set S7, there can be extracted <“Can anyone help with bathing?,” Anyone, Person, Indefinite>, <“Can anyone help with bathing?,” Bathing, Role, Work>, <“Can anyone help with bathing?,” Help with, Role, Work> and <“Can anyone help with bathing?,” Can you?, Intention, Request>. However, no process rules are available for this. Hence, the process is terminated for the speech waveform data V7.
(t36) Then, it is assumed that the following speech waveform data V8 is acquired, as the speech of the user D, from the terminal 4.

V8=User D: “I will do it.” (t37) The speech analysis unit 153 performs Step S702 shown in FIG. 7, generating an entry corresponding to the speech information address 201 “J8” in the speech information table shown in FIG. 2. The speech analysis unit 153 then refers to the keyword list, performing the keyword spotting process on the speech data V8 and acquiring the speech analysis result for the entry corresponding to the analysis result address 401 “K8” shown in FIG. 4.

(t38) The utterance-pair detection unit 154 determines whether or not any utterance-pair exists. In the speech represented by the speech waveform data V7, the second classification of the surface expression, “Can you?,” is “Request.” In the speech represented by the speech waveform data V8, the second classification of the surface expression, “Do it,” is “Request granted.” Thus, the speeches represented by the speech waveform data V7 and V8 constitute an utterance-pair that corresponds to the detection rule address 501 “M1.” This utterance-pair, i.e., speech waveform data V7 and V8, is recorded at the entry β1 of the utterance-pair address 601 shown in FIG. 6.
(t39) The utterance-pair detection unit 154 generates a set S8 including the speech waveform data V7 and the speech waveform data V8.
(t40) The role identification unit 155 identifies the speech waveform data V7. From the speech waveform data V7, there are extracted <“Can anyone help with bathing?,” bathing, Role, Work >, <“Can anyone help with bathing?,” help with, Role, Work> and <“Can anyone help with bathing?,” can you?, Intention, Request>. From the speech waveform data V8, there are extracted <“I will do it,” I, Person, Subject> and <“I will do it,” do it, Intention, Request granted>. This state accords with the process rule 4. Therefore, the user D is extracted from the entry of the speech waveform data V8, and “help with bathing” is recorded in the column of role name 802, in the table 904 (FIG. 9) stored in the role storage 156.
(t41) Next, the following speech waveform data V9, as the speech the user Y has made, is acquired from the terminal 8.

V9=User Y: “Please tell ⋄⋄ to anyone helping with bathing.”

(t42) The speech analysis unit 153 performs Step S702 shown in FIG. 7, generating an entry corresponding to the speech information address 201 “J9” in the speech information table shown in FIG. 2. The speech analysis unit 153 then refers to the keyword list, performing the keyword spotting process on the speech data V9 and acquiring the speech analysis result for the entry corresponding to the analysis result address 401 “K9” shown in FIG. 4.
(t43) The utterance-pair detection unit 154 determines whether or not any utterance-pair exists. No utterance-pairs are detected since no patterns accord with the utterance-pair detection rule for the speech data V1 to V9.
(t44) The role identification unit 155 generates a set S including the speech waveform data V9 only.
(t45) The role identification unit 155 identifies the speech waveform data V9. From the speech waveform data V9 existing in the set S9, there are extracted <“Please tell ⋄⋄ to anyone helping with bathing,” Bathing, Role, Work>, <“Please tell ⋄⋄ to anyone helping with bathing,” Help with, Role, Work> and <Please tell ⋄⋄ to anyone helping with bathing,” Tell it, Notification, ->. Since the combination of these items accords with <Process Rule 5>, the user Y's speech waveform data V9 is conveyed to the user D assigned to “help with bathing.” Thus, remote communication can be achieved, informing many users that some other users are busy and are therefore asking for assistance.

In the first embodiment described above, the rule of changing and adding roles in accordance with the classification of keywords is applied to role changes dynamically determined from the speeches of several users. The roles added and changed can therefore be reliably detected, and the helpers can assist one another through remote communication. Moreover, no confusion occurs in mutual assistance since necessary information is given to only the users assigned to specific roles, giving no unnecessary information to any users not assigned to roles. Thus, the embodiment can achieve appropriate linked-work assistance.

### Second Embodiment

The second embodiment differs from the first embodiment, in that the speeches are monitored, identifying any person too busy to ask other users for help and thus broadcasting that the user is busy.

A helper may keep talking with a person for a long time while helping the person. Alternatively, the helper may serve many persons, from one person to another, while frequently talking with them, without talking or communicating with any other helpers. In either case, the helper is too busy to ask other helpers for assisting him or her. This is why the second embodiment determines that the helper is so busy and then asks the other helpers for assistance, in place of the busy helper.

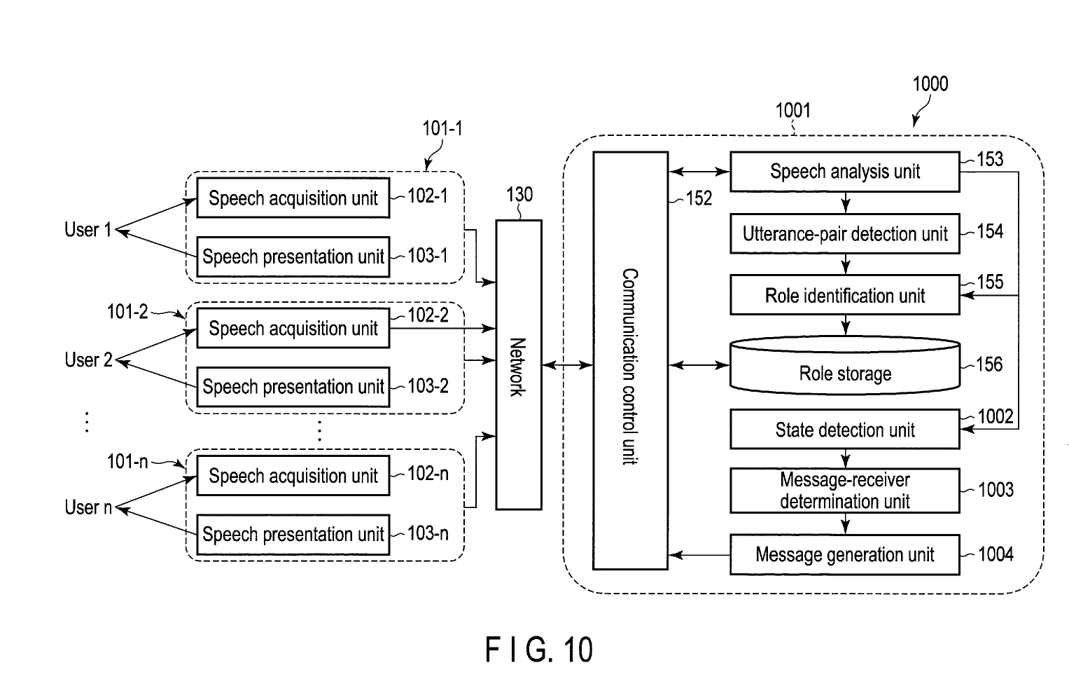

A linked-work assistance system according to the second embodiment, which includes a linked-work assistance apparatus, will be described with the block diagram of FIG. 10.

The linked-work assistance system 1000 according to the second embodiment includes terminals 101 and a linked-work assistance apparatus 1001.

The linked-work assistance apparatus 1001 includes a communication control unit 152, a speech analysis unit 153, an utterance-pair detection unit 154, a role identification unit 155, a role storage 156, a state detection unit 1002, a message-receiver determination unit 1003, and a message generation unit 1004.

The terminals 101, the communication control unit 152, the speech analysis unit 153, the utterance-pair detection unit 154, the role identification unit 155, and the role storage 156 are similar to those used in the first embodiment, and will not described.

From the result of the speech analysis performed by the speech analysis unit 153, the state detection unit 1002 detects persons talking with a user and the time they have been talking with the user, and then generates speech state information about the user. From the speech state information, the state detection unit 1002 determines whether or not the other users must be informed that the user is busy. To determine this, the state detection unit 1002 may use, as threshold values, the positional distribution of the persons talking with the user, the number of persons the user has served in a prescribed time unit and the time the user has talked with these persons. If any one of these threshold values is reached, the speech state information about the user is sent to the message-receiver determination unit 1003. The role identification unit 155 may determine whether or not the other users should be informed of the user's busy state.

The message-receiver determination unit 1003 receives the speech state information from the state detection unit 1002, extracts the user ID of the user from the speech information table based on the speech state information, and determines other users who should be informed that the user is busy. The other users are referred to as target users. In example, all other users of the linked-work assistance system 1000 may be so informed. Instead, the busy user's superior or teammates may be so informed, in accordance with the skills they have or the roles they are performing.

The message generation unit 1004 receives the user ID from the message-receiver determination unit 1003, and generates a message showing that the user is busy. The message is a template message, such as “Ms. ◯◯ seems very busy now,” or any other message by which the other users can easily understand that the user is busy. The message generated in the message-receiver determination unit 1003 is transmitted via the communication control unit 152 to the terminals 101 used by the users who should receive the message.

The threshold value used to determine whether or not the user is busy is adjusted and used to detect that the user is likely to get busy soon, and the other users are informed that the user will soon get busy. This can help to avoid confusion, delay, failure or trouble in the work of the part of the user, even though the user is quite busy.

According to the second embodiment described above, even if a user is too busy to ask the other users for assistance, by detecting the situation of the user based on the speech state information, the apparatus can inform the other users of the situation of the user. The other users therefore know the user actually needs help and can appropriately assist the user.

The linked-work assistance system according to this embodiment can enable remote communication between many people who engage in linked work. Further, any utterance-pair can be detected even if either speech is discontinuous in time, for example, an embed dialog may be used for the other users' confirmation interjections. A morpheme analysis may be performed to extract keywords, in accordance with inflections, such as declension and conjugation. Moreover, priority information may be added to the utterance-pairs which match one another in pair structure, and any ambiguous utterance-pair may be clarified on the basis of the priority information. Not only utterance-pairs, but also the information about ordinary conversation structures may be utilized.

An object searched for may not be found when referring to the role storage 156. If this is the case, an alarm may be given to the user.

In the embodiments described above, the information the users must have in common is presented to the users in the form of speech signals. Nonetheless, the information may be presented in the form of, for example, image data to specified users through some means. Alternatively, the information may be presented in such a form that many users can refer to. Thus, the media utilized need not be limited to speech. Further, the speech state information may be used together with not only the speech analysis result, but also information acquired by, for example, a position estimation technique, behavior estimation technique or any other technique available, and background information such as the work schedule, occupation and specialty.

Some of the users are persons in nursing homes, patients in hospitals or infants in nurseries. In such a case, these users need not have their own data terminals.

Moreover, the speech acquisition units and the speech presentation units may be set in the space. In this case, the users need not hold the terminals. Alternatively, some speech acquisition units and some speech presentation units may be used a combination of a form of the terminals and a form of being set in the space.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A linked-work assistance apparatus, comprising:
an analysis unit configured to analyze a speech of a user by using a keyword list, to acquire a speech analysis result indicating a relation between a first keyword and a classification of the first keyword if the first keyword included in the speech, the keyword list indicating a list of keywords classified based on concepts of the keywords and intentions of the keywords, the first keyword being one of the keywords included in the keyword list;
an identification unit configured to identify a role of the user according to the classification of the first keyword, to acquire a correspondence relation between a plurality of users and the roles corresponding to the users; and
a control unit configured to, if the speech includes a name of the role, transmit the speech to one or more other users which relate to the role corresponding to the name, by referring to the correspondence relation.

2. The apparatus according to claim 1, further comprising a first detection unit configured to detect a utterance-pair which represents another relation between speeches of the users, in accordance with a combination of classifications of a plurality of first keywords included in the speeches, wherein the identification unit identifies the role based on at least one of the speech analysis result and the utterance-pair.

3. The apparatus according to claim 1, wherein the name of the role is at least any one of, a work name, a position name, a group name, a team name, a shift name, a target name, a service-receiver name, a service-place name and a service time which relate to a user.

4. The apparatus according to claim 1, further comprising a storage configured to store the correspondence relation, wherein the identification unit updates the correspondence relation on determining that the role of the user changes or an additional role assigns to the user based on the combination of classifications of a plurality of first keywords.

5. The apparatus according to claim 1, further comprising a second detection unit configured to detect one or more persons talking with the user and the time the persons talking with the user to generate speech state information relating to the user, wherein the identification unit determines, based on the speech state information, whether or not a notification to the other users are needed.

6. The apparatus according to claim 5, further comprising:
a generation unit configured to generate a message including information to be given to the other users; and
a determination unit configured to determine at least one of target users based on the speech state information and the correspondence relation if the notification are needed in consideration of the speech state information, each of the target users being one of the other users to receive the message.

7. A linked-work assistance method, comprising:
analyzing a speech of a user by using a keyword list, to acquire a speech analysis result indicating a relation between a first keyword and a classification of the first keyword if the first keyword included in the speech, the keyword list indicating a list of keywords classified based on concepts of the keywords and intentions of the keywords, the first keyword being one of the keywords included in the keyword list;
identifying a role of the user according to the classification of the first keyword, to acquire a correspondence relation between a plurality of users and the roles corresponding to the users; and
transmitting the speech to one or more other users which relate to the role corresponding to the name by referring to the correspondence relation if the speech includes a name of the role.

8. The method according to claim 7, further comprising detecting a utterance-pair which represents another relation between speeches of the users, in accordance with a combination of classifications of a plurality of first keywords included in the speeches,
wherein the identifying the role identifies the role based on at least one of the speech analysis result and the utterance-pair.

9. The method according to claim 7, wherein the name of the role is at least any one of, a work name, a position name, a group name, a team name, a shift name, a target name, a service-receiver name, a service-place name and a service time which relate to a user.

10. The method according to claim 7, further comprising storing, in a storage, the correspondence relation, wherein the identifying the role updates the correspondence relation on determining that the role of the user changes or an additional role assigns to the user based on the combination of classifications of a plurality of first keywords.

11. The method according to claim 7, further comprising detecting one or more persons talking with the user and the time the persons talking with the user to generate speech state information relating to the user,
wherein the identifying the role determines, based on the speech state information, whether or not a notification to the other users are needed.

12. The method according to claim 11, further comprising:
generating a message including information to be given to the other users; and
determining at least one of target users based on the speech state information and the correspondence relation if the notification are needed in consideration of the speech state information, each of the target users being one of the other users to receive the message.

13. A non-transitory computer readable medium including computer executable instructions, wherein the instructions, when executed by a processor, cause the processor to perform a method comprising:
analyzing a speech of a user by using a keyword list, to acquire a speech analysis result indicating a relation between a first keyword and a classification of the first keyword if the first keyword included in the speech, the keyword list indicating a list of keywords classified based on concepts of the keywords and intentions of the keywords, the first keyword being one of the keywords included in the keyword list;
identifying a role of the user according to the classification of the first keyword, to acquire a correspondence relation between a plurality of users and the roles corresponding to the users; and
transmitting the speech to one or more other users which relate to the role corresponding to the name by referring to the correspondence relation if the speech includes a name of the role.

14. The medium according to claim 13, further comprising detecting a utterance-pair which represents another relation between speeches of the users, in accordance with a combination of classifications of a plurality of first keywords included in the speeches,
wherein the identifying the role identifies the role based on at least one of the speech analysis result and the utterance-pair.

15. The medium according to claim 13, wherein the name of the role is at least any one of, a work name, a position name, a group name, a team name, a shift name, a target name, a service-receiver name, a service-place name and a service time which relate to a user.

16. The medium according to claim 13, further comprising storing, in a storage, the correspondence relation, wherein the identifying the role updates the correspondence relation on determining that the role of the user changes or an additional role assigns to the user based on the combination of classifications of a plurality of first keywords.

17. The medium according to claim 13, further comprising detecting one or more persons talking with the user and the time the persons talking with the user to generate speech state information relating to the user,
wherein the identifying the role determines, based on the speech state information, whether or not a notification to the other users are needed.

18. The medium according to claim 17, further comprising:
generating a message including information to be given to the other users; and
determining at least one of target users based on the speech state information and the correspondence relation if the notification are needed in consideration of the speech state information, each of the target users being one of the other users to receive the message.
